(19) United States
(12) Patent Application Publication
(10) Pub. No.: US 2012/0279120 A1
(43) Pub. Date: Nov. 8, 2012

(54) SUBSURFACE HEAT ACTUATED EVAPORATIVE IRRIGATION METHOD AND SYSTEM

(75) Inventor: Mark Randell Prescott, Stephentown, NY (US)

(73) Assignee: AgroSci, Inc., Stephentown, NY (US)

(21) Appl. No.: 13/284,278

(22) Filed: Oct. 28, 2011

Related U.S. Application Data
(60) Provisional application No. 61/455,905, filed on Oct. 28, 2010.
(60) Provisional application No. 61/444,603, filed on Feb. 18, 2011.
(60) Provisional application No. 61/571,190, filed on Jun. 22, 2011.

(51) Int. Cl. A01G 29/00

(52) U.S. Cl. 47/48.5

(57) ABSTRACT

A subsurface heat actuated evaporative irrigation system includes a receptacle defined by a porous outer wall. The receptacle includes a first inlet for receiving water and a second inlet for receiving air. The system further includes a heating unit for heating water received in the receptacle to form vapor, wherein the vapor and the air in the receptacle permeate through the porous outer wall of the receptacle into a planting medium.

### CROSS REFERENCE TO RELATED APPLICATIONS

This application claims priority from the following U.S. Provisional Patent Applications, all of which are incorporated herein by reference: (1) U.S. Provisional Patent Application No. 61/455,905, filed on Oct. 28, 2010, entitled HEAT ACTUATED AERATION AND WATERING SYSTEM FOR PLANT GROWING CONTAINER. SUPPLIES AIR, MOISTURE, HEAT FOR BETTER GROWTH AND CONSERVATION OF WATER, (2) U.S. Provisional Patent Application No. 611571,190, filed on Jun. 22, 2011, entitled SUB-SURFACE HEAT ACTUATED WATERING HEAT REGULATING SYSTEM FOR VERTICAL WALL PLANTINGS, and (3) U.S. Provisional Patent Application No. 61/444,603, filed on Feb. 18, 2011, entitled SUBSURFACE HEAT EVAPORATIVE LIFT IRRIGATION SYSTEM.

### BACKGROUND

The present application relates generally to irrigation systems and, more particularly, to a subsurface heat actuated evaporative irrigation system.

Effective operation of traditional irrigation systems relies on the operator understanding the soil conditions or expensive electronic monitoring equipment. Standard overhead watering, drip or sub-surface irrigation systems are often inefficient and waste water through evaporation and from water percolating down through soil and root system, leaving the container or draining deeply into the ground where plant roots cannot access it. As inefficient as traditional watering processes are, the wasted water does perform the function of allowing air to be brought into the soil and root zone from the vacuum created by water draining out of container or through the soil. Creating proper water to air ratios in soils and root zones is very important for healthy roots and creating the proper beneficial bacterial colonies for preventing plant disease and for proper mineral absorption.

### BRIEF SUMMARY OF THE DISCLOSURE

A subsurface heat actuated evaporative irrigation system in accordance with one or more embodiments includes a receptacle defined by a porous outer wall. The receptacle includes a first inlet for receiving water and a second inlet for receiving air. The system further includes a heating unit for heating water received in the receptacle to form vapor, wherein the vapor and the air in the receptacle permeate through the porous outer wall of the receptacle into a planting medium.

### BRIEF DESCRIPTION OF THE DRAWINGS

FIG. 1 is a simplified illustration of an irrigation system in accordance with one or more embodiments.

FIGS. 2A-2C illustrate an irrigation system in accordance with one or more further embodiments.

FIGS. 3A and 3B illustrate operation of the irrigation system of FIGS. 2A-2C.

FIGS. 4A and 4B illustrate an irrigation system implemented in a vertical wall system in accordance with one or more further embodiments.

FIG. 5 illustrates an irrigation system for use with row crops in accordance with one or more further embodiments.

FIG. 6 illustrates an irrigation system for use with mass planting crops in accordance with one or more further embodiments.

FIG. 7 illustrates an irrigation system for use in a container in accordance with one or more embodiments.

FIG. 8 illustrates an irrigation system used in a raised bed planter in accordance with one or more embodiments.

FIG. 9 illustrates a saltwater irrigation system in accordance with one or more embodiments.

FIGS. 10A and 10B illustrate an irrigation system with a disk heater in accordance with one or more embodiments.

### DETAILED DESCRIPTION

The present application is directed to a subsurface heat actuated evaporative irrigation system. Irrigation systems in accordance with various embodiments can be used with plants grown in a wide variety of settings including in containers, raised beds, commercial farms, or on vertical walls. Vertical walls can include, e.g., biofilter walls and green walls using phytoremediation techniques.

The system can be used with plants grown indoors. It is well known that having plant material within a dwelling, work area or living area is beneficial both in improving the look and feel of an interior space and providing positive health effects by improving air quality from the removal of CO2. Plants also have the ability to remove indoor toxins that can be harmful.

Irrigation systems in accordance with various embodiments can be used with vertical planting systems to reduce the formation of algae and molds, which is a common problem with currently used vertical planting systems, particularly those used in interior spaces. The ability to reduce algae build in ventilation systems extends the usable life of mechanical air filters.

Irrigation systems in accordance with various embodiments can include a self-regulating feature that enables the system to inject more moisture at higher elevations of vertical walls (which are subject to warmer and thus drier conditions) and less moisture to lower elevation levels (which are cooler). This allows easier maintenance of vertical green walls.

In accordance with one or more embodiments, positive air pressure is created by a diaphragm pump, which increases plant absorption of indoor airborne contaminates.

Plants that filter toxins allow air to be recycled in indoor spaces. Ventilation rates can thereby be waned, resulting in energy savings in HVAC systems.

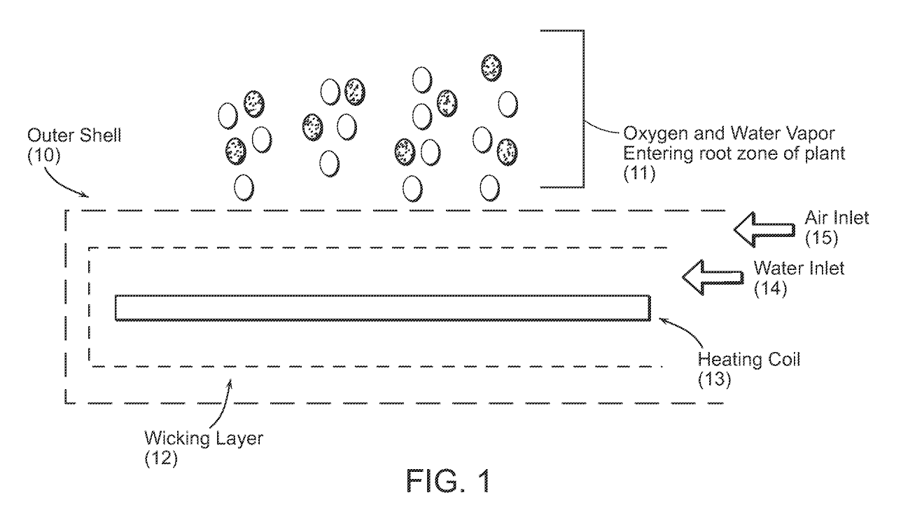

FIG. 1 is a simplified diagram illustrating an irrigation system in accordance with one or more embodiments. FIG. 1 illustrates the functions of heat, water, air, and how they work together to get water into the soil as a vapor. The irrigation system includes an outer layer of material 10, which comprises a material such as a semi-permeable membrane or a porous rubber material that keeps liquid water in only letting water out through the material as a vapor.

The irrigation system includes a water inlet and a wicking layer 12, which bring in moisture to a heat source 13. The heat source heats the water to a temperature of about 140-160° F. In some embodiments, particularly for small applications, the water source can be wicking material. Alternately, the water source can be under low pressure for larger applications. Air is brought into system at an inlet 15, e.g., from a diaphragm pump or blower. The air improves the evaporation rate of the water heated by the heater. The air also infuses oxygen into plant root zones for better soil structure and plant health. The system thereby improves the efficiencies of evaporative irrigation systems, making them practical from a cost perspective and efficient enough to water plants. Air and water in vapor form enter the root zone of a plant as indicated at 11.

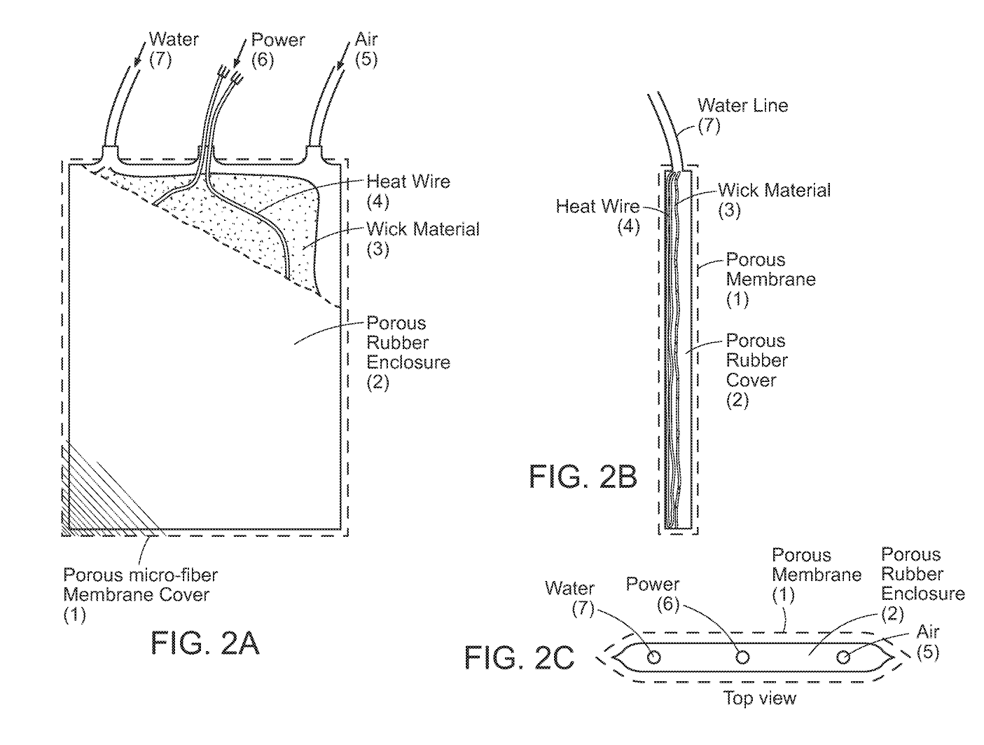

FIGS. 2A, 2B, and 2C are front, side, and top views, respectively, of an irrigation system in accordance with one or more further embodiments. The illustrated system is particularly applicable for vertical wall plantings for air filtration, FIGS. 2A-2C represent one possible shape or design of an irrigation system that can be added to modular growing systems. It should be understood that the shape and wattage output can be altered to accommodate different sized planting containers or pockets. The system includes a porous rubber enclosure 2 comprising a porous rubber material or semi-permeable membrane that allows for the vapor and air to escape into a plant root zone. The porous rubber enclosure 2 contains a fiberglass wick 3 and heat wire 4 contained in the fiberglass wick. Power is supplied to the heat wire 4 by a power line 6. Water is introduced into system through a tube 7. The water is contained in a porous micro-fiber membrane 1 until heat from the heat wire 4 and air introduced through an air inlet 5 force water vapor out through the porous enclosure 2 into root zone medium. This process insures the cleanliness of the planting and growing area and generally eliminates algae and mold that might compromise a main feed that is under low pressure, e.g., 2-5 PSI. Electrical connections of the power line 6 are completed outside of the enclosure to insure safety from shock. Wattage requirements will vary depending on size of planter and can be low wattage if required. Air is supplied through a main line at air inlet 5. Positive pressure is maintained through a diaphragm pump. The air flow created through pump creates and maintains aerobic conditions and improves the filtering potential of plants because air contaminants are also absorbed through roots and stored in plant material and consumed by beneficial bacteria in root zone.

FIG. 2B, a side view of the system, shows the water line 7, the wick material 3, which encloses the heat wire 4, rubber membrane 2, which encloses the wick material 3. The rubber membrane isolates the water feed 7, power feed 6, and air feed 5 also seen in FIG. 2C. The entire system is enclosed by a porous micro-fiber membrane 1.

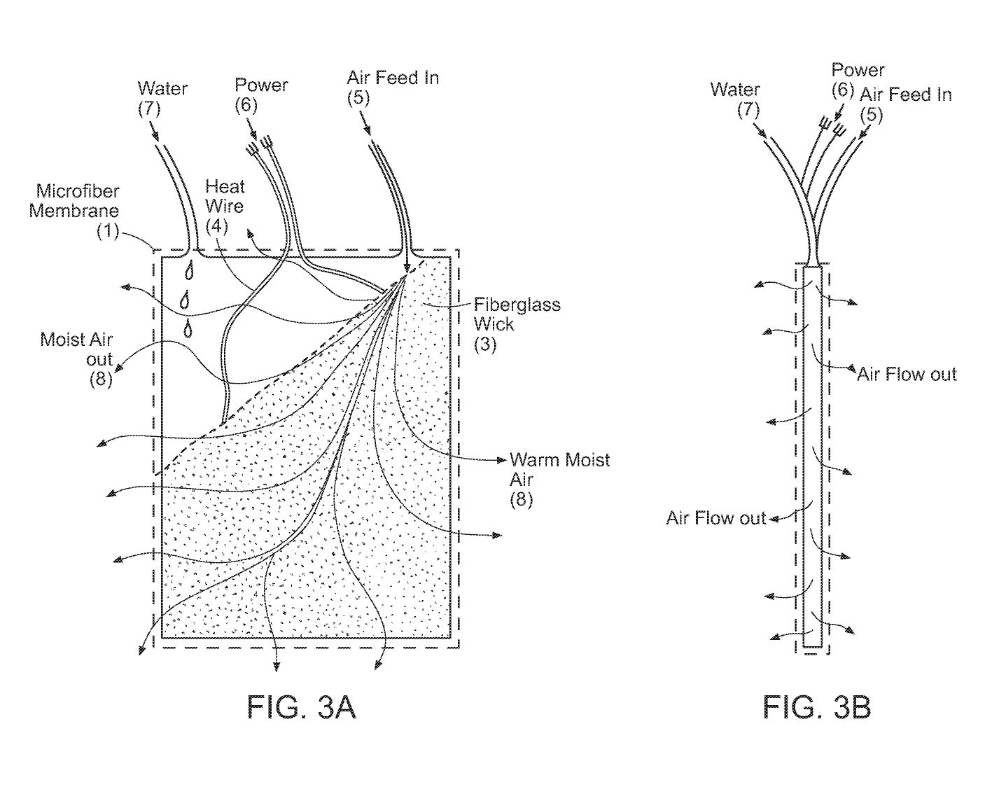

FIGS. 3A and 3B illustrate operation of the system. Water flowing into system from feed 7 is distributed generally evenly by wick 3 and heated by heat wire 4. The water evaporates off and is carried out of system with the air from the air feed 5 through micro-fiber membrane 1 and out as moist air 8, where it goes into the root zone. FIG. 3B is a side view of system showing water line 7, power feed 6, and air feed 5. This view demonstrates air flow out through both sides of system into root zone.

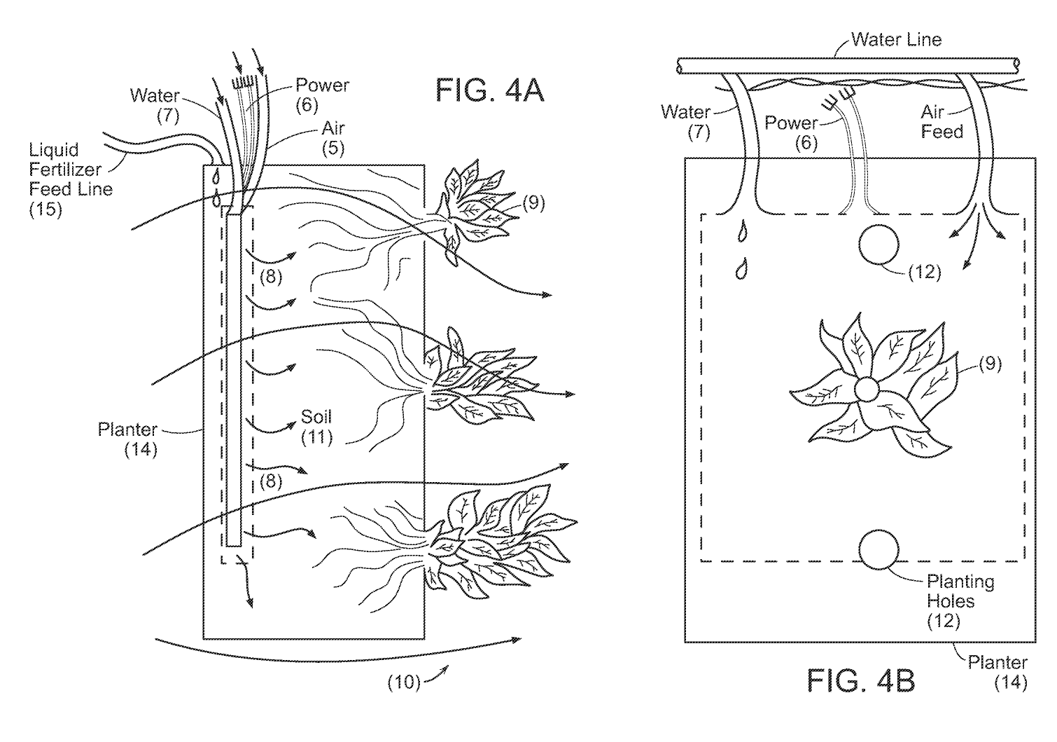

FIGS. 4A and 4B illustrate an irrigation system in accordance with one or more further embodiments implemented in a planting pocket in a vertical wall system. Water, power, and air flow into the system at feeds 7, 6, 5, respectively. Air and water vapor come out into the soil medium at 8 with roots 11. The exiting air is cleaned as roots and soil bacteria uptake toxins in the air, which are consumed by and stored in plant. Soil bacteria also will process certain airborne toxins. Air flow will pass over mass plantings and clean, remove CO2, and create oxygen for the interior space. FIG. 4B is a front view of planter containing the irrigation system including feeds for water 7, power 6, and air 5. Liquid fertilizer feed line 15 demonstrates a drip irrigation feed system for fertilizing plants in vertical planting systems.

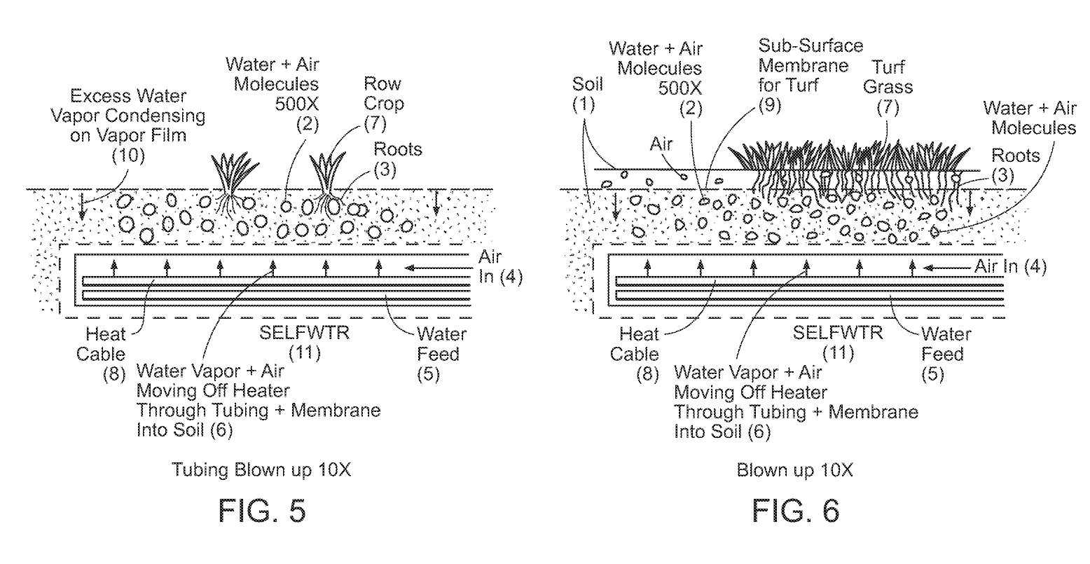

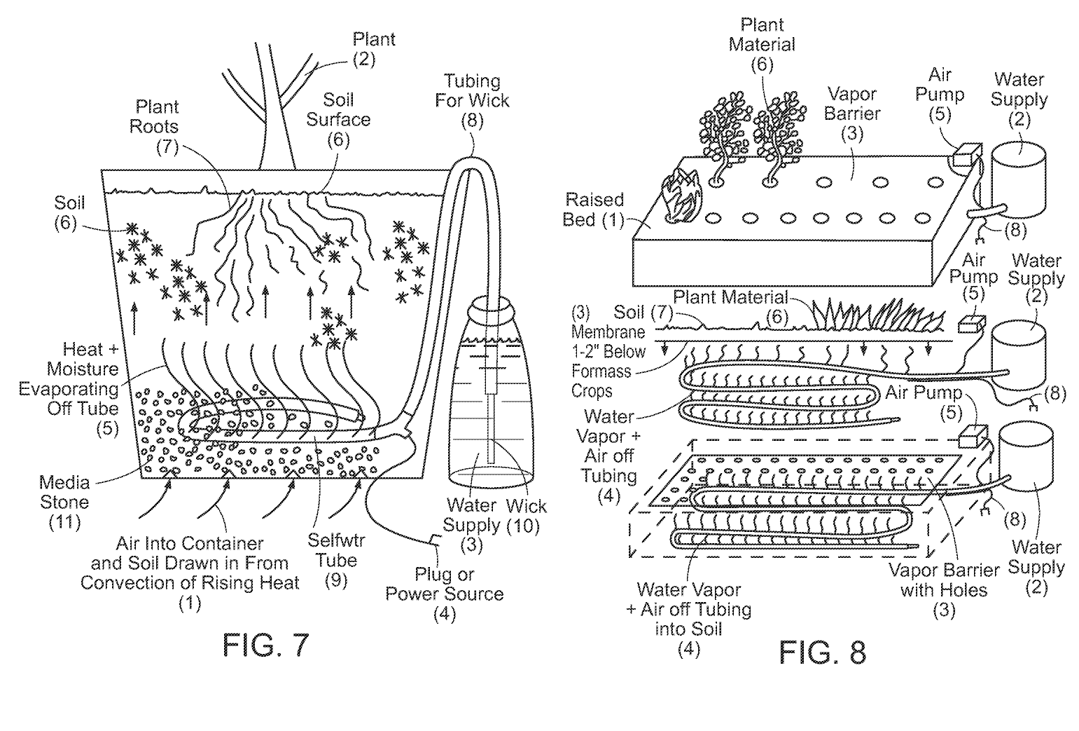

FIG. 5 shows a cross-section view of irrigation system 11 with tubing used for row crops. For purposes of illustration, the tubing size is shown significantly larger than normal. The system 11 includes all the components described above with respect to FIG. 1. Water is pumped or wicked into system where heater 8 brings temperature up to the 160 degrees Fahrenheit range, air 4 pumped in and pushes through with the moisture, condensing on root system and vapor barrier for uptake to plant,

FIG. 6 illustrates irrigation tubing in accordance with one of more further embodiments for growing Turf or other mass plantings like greens where plants are not in rows. The tubing is shown significantly larger than normal for purposes of illustration. The system works in similar fashion to FIG. 5. However, a perforated vapor barrier is used sub-surface under 1-2 inches of soil where grass or greens are planted in. Evaporation will slow and water can be utilized by plants through the perforated membrane.

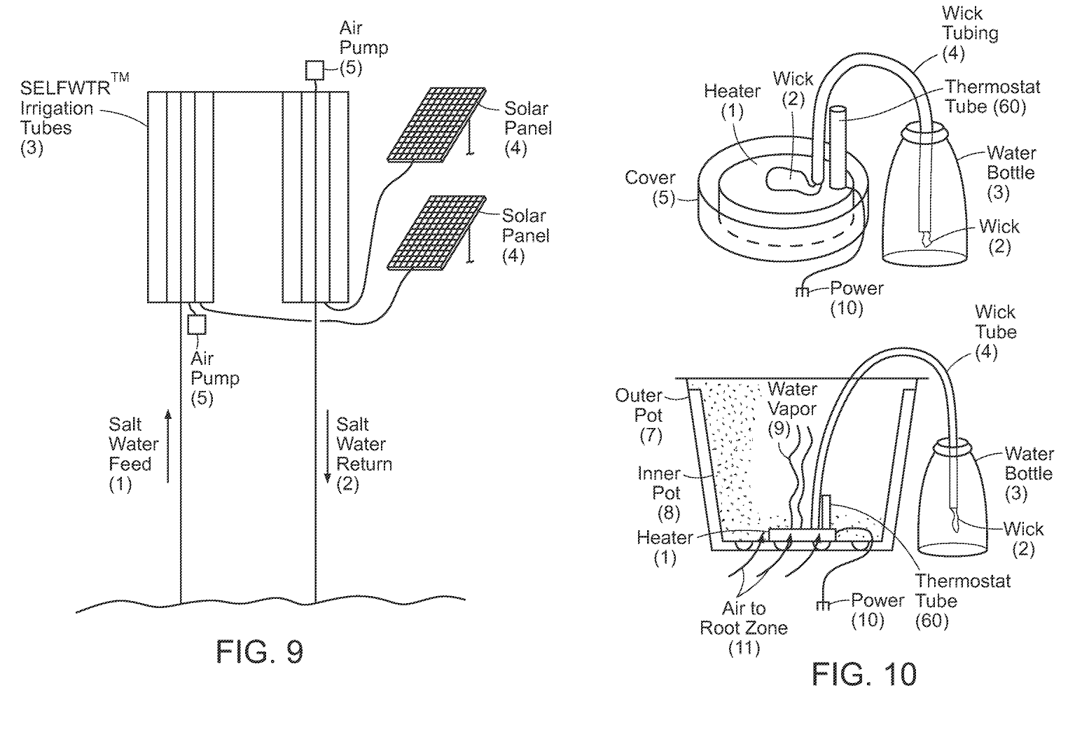

FIG. 10 shows irrigation tubing used in a small container in accordance with one or more further embodiments. The tubing 9 uses a bottle and wick for a water source 3 and 10. Water is heated in tube using power from power source 4. Convection is created from the rising heat and moisture 5 and draws in air 1 to oxygenate the soil, and balance water to air ratio. The system sits in media stone 11 for creating an even heat distribution of heat.

FIG. 8 illustrates an irrigation system in accordance with one or more further embodiments used in a raised bed planter. A raised bed 1 is covered with a vapor barrier 3. Water is fed by a reservoir 2. Air is provided using a small air pump. Water vapor and air move off irrigation system into the soil media 4 to water and oxygenate the soil and roots. Depending on the plants grown, a surface membrane 3 is used or a sub-surface membrane is used for turf or greens. The system can be powered by standard 110 volt plug 8 or a solar panel.

FIG. 9 shows a flow through system in accordance with one or more further embodiments in which salty or brackish water is used for irrigation. The system works in similar fashion to a fresh water system. However, water is pulled from a water source through 1 and water slowly passes through irrigation tubes 3 where fresh water is evaporated off system. An air pump 5 pushes air through the system and helps facilitate faster evaporation from the system. Water leaves the system back to the source through feed 2 with a higher saline content from where it entered. This process solves the problem of salt buildup, which is a significant problem in salt water irrigation. The whole system can be powered by solar panels 4 or other power source.

Irrigation systems in accordance with various embodiments can have many forms, shapes and configurations. For example, FIG. 10A illustrates a heat source in the form of a disk 1. The heater is controlled by a thermostat built into a tube 6. Tubing 4 containing a wick is placed into a water source 3 for feeding water to heater 1. As shown in FIG. 10B, water is evaporated into soil as a vapor 9 and absorbed by plant roots. Air is drawn into pot and root system by convection 11.

Irrigation systems in accordance with various embodiments utilizing temperature regulation can solve problems of overwatering, wasted water, anaerobic soils, the need for costly monitoring equipment, clogging of micro-or drip systems. Systems in accordance with various embodiments are scalable to generally any planting configurations from vertical walls to commercial farm irrigation. Irrigation systems in accordance with various embodiments are also self-regulating, without the need for costly electronic equipment.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. Accordingly, the foregoing description and attached drawings are by way of example only, and are not intended to be limiting.

What is claimed is:

1. A subsurface heat actuated evaporative irrigation system, comprising:
a receptacle defined by a porous outer wall, said receptacle having a first inlet for receiving water and a second net for receiving air; and
a heating unit for heating water received in the receptacle to form vapor, wherein the vapor and the air in the receptacle permeate through the porous outer wall of the receptacle into a planting medium.

2. The irrigation system of claim 1, wherein the heating unit comprises an electric heater or hot water tubing.

3. The irrigation system of claim 1, wherein the porous outer wail comprises a porous rubber membrane, and wherein the porous rubber membrane is wrapped in a permeable membrane to trap liquid water.

4. The irrigation system of claim 1, wherein transfer of air into the receptacle accelerates evaporation for more efficient water transfer to roots and adds oxygen to the planting medium.

5. The irrigation system of claim 1, further comprising a wicking material to more evenly distribute water in the receptacle.

6. The irrigation system of claim 1, wherein the system is configured for use in a vertical wall planting system, and can be added or removed from a planter in the vertical wall planting system.

7. The irrigation system of claim 1, wherein the heating unit heats the water to a temperature of 140-160 degrees Fahrenheit to inhibit algae build up and clogging.

8. The irrigation system of claim 1, wherein the heating unit is wrapped in a fiberglass wicking cloth, and wherein the porous outer wall comprises a porous rubber material that is encased in a semipermeable membrane

9. A subsurface heat actuated evaporative irrigation system for use in a plant growing container, comprising:
a porous receptacle disposed in a planting medium in the plant growing container, said porous receptacle having an inlet for receiving water; and
a heating unit for heating water received in the receptacle to form vapor, wherein the vapor in the receptacle permeates through the receptacle into the planting medium, creating convection for air infusion into the plant growing container.

10. The system of claim 9, wherein the porous receptacle comprises a porous tube, and water is introduced into the porous tube through a fiberglass wicking material in the tube.

11. A salt water irrigation system comprising:
a porous receptacle having an inlet for receiving salt water and an outlet for discharging unevaporated salt water; and
a heating unit for heating saltwater received in the receptacle to form vapor, wherein the vapor in the receptacle permeates through the receptacle into a planting medium.
